(19) United States
(12) Patent Application Publication
(10) Pub. No.: US 2003/0008042 A1
(43) Pub. Date: Jan. 9, 2003

(54) Food product with nutraceuticals and packaging for same

(76) Inventors: Soram Singh Khalsa, Los Angeles, CA (US); Jerry Chen, Los Angeles, CA (US); Andrew I. Wolf, Los Angeles, CA (US); Sanford B. Weiss, Los Angeles, CA (US); Richard A. Ehrman, Malibu, CA (US)

Correspondence Address: MATTHEW A. NEWBOLES, STETINA BRUNDA GARRED & BRUCKER, SUITE 250, 75 ENTERPRISE, ALISO VIEJO, CA, 92656, US

(21) Appl. No.: 10/231,594

(22) Filed: Aug. 30, 2002

Related U.S. Application Data
(63) Continuation of application No. 09/564,188, filed on May 4, 2000.

(51) Int. Cl. A23B 4/00

(52) U.S. Cl. 426/120

(57) ABSTRACT

Disclosed is a combination food and nutraceutical package which provides convenient and easy access to a food product and at least one nutraceutical. The packaging comprises two segments which secure the food product and the nutraceutical so as to provide a shelf-stable environment that prevents contamination between the various contents. In one embodiment, a single nutraceutical is packaged with a food product. In other embodiments, multiple nutraceuticals with a food product are secured. In yet another embodiment, the food product and nutraceuticals are placed within a tray and then sealed with the two segments. The food product is preferably a fruit based substance, but it may take other forms. The nutraceuticals may be a solid mass, in pill or capsule form, or they may be liquid housed within a container.

### BACKGROUND OF THE INVENTION

1. Field of the Invention

The present invention relates to combination packaging for food products and nutraceuticals.

2. Description of the Related Art

The treatment of various ailments and diseases is increasingly including dietary regimens in addition to traditional medicinal therapies. Such combination treatments are particularly used in connection with individuals afflicted with cancer, human immunodeficiency virus, or acquired immune deficiency syndrome where the afflictions weaken the individuals' immune systems. With such individuals, food-based nutrients can greatly enhance the effects of traditional medical therapy. In addition, it has been determined that herbs, vitamins, minerals, protein, functional foods, and medical foods (collectively referred to herein as “nutraceuticals”), can also boost the immune system of an individual thereby warding off existing ailments and preventing others from manifesting. Most nutraceuticals are believed to have potentially disease-preventing and health-promoting properties and are part of a rapidly growing industry.

While many nutraceuticals have yet to be the subject of extensive clinical studies, they have become quite popular throughout the world for treating various existing conditions, and for use as preventative measures. For example, shark cartilage is believed to benefit those with arthritis and cancer. Chitosan can help individuals with high cholesterol and weight problems. Herbs such as kava kava, valerian, St. John's wort, skullcap, passionflower, hops, chamomile, rhodiola rosea extract, aven sativa, and griffonia are all used to treat stress-related conditions.

Other types of nutraceuticals, mainly vitamin and mineral supplements, have been clinically proven to prevent degenerative diseases and to ward off other afflictions. It has been established that regular calcium intake prevents osteoporosis, a soy-based diet reduces one's risks of various cancers such as breast and prostate cancer, and zinc, vitamin C and vitamin K reduce the effects of bruising of the skin. In addition, antioxidants such as folic acid have been shown to prevent diseases such as leukemia, and nicotinic acid has been shown to dramatically reduce the risks of heart disease, all at a fraction of the cost of pharmaceutical drugs.

Although the consumption of nutraceuticals has been found to be an effective alternative or supplement to medicinal therapies, unfortunately, individuals stricken with serious ailments often fail to follow their doctor-recommended dietary regimens. Such failures are often due in part to the inconvenience of preparing and finding foods with particular desirable nutrients.

Moreover, doctors frequently recommend nutriceuticals that may necessitate the taking of many different pills much to the displeasure of some patients. Matching foods with complimentary nutriceuticals can provide desirable benefits while reducing total food and pill intake. The smaller required intake thereby increases the likelihood of a patient's adherence to the recommended combination treatment.

Complimentary food and nutraceutical combinations can also increase the performance and training of athletes while also providing energy boosts to ordinary people. In recent years, there have been a large influx of human engineered food products such as snack bars available under the trademarks POWERBARS™ and CLIF BARS™. While these food products present an improvement over past food products, they do not provide some of the benefits that a food product with separate complimentary nutraceuticals can offer based on the inherent limitations of preserving most nutriceuticals within a food mass.

Nutraceuticals can take the form of powders, liquids, pills (including capsules, gelcaps, tablets, etc.), and other solid masses depending on their base ingredients and the preferred method of delivery (i.e., instant, time-release). Powders can be packaged in sealed plastic bags or other suitable containers that facilitate consumption by an individual. Single-dosage liquid nutraceuticals are typically housed in tearable plastic containers (e.g., honey sticks), or they may be housed within edible wax containers. While single-dosage nutraceuticals are currently available within specialized stores, the end users rarely simultaneously consume a complimentary food product, thereby lessening the effectiveness of the nutraceuticals.

Accordingly, it should be appreciated that there is a definite need for a more convenient consumer product housing food and complimentary nutraceuticals.

### SUMMARY OF THE INVENTION

The present invention is embodied in a package for a food product and a nutraceutical, the package comprising a first segment and a second segment. The two segments secure a food product, such as a fruit based substance, and a nutraceutical that is preferably in the shape of a pill. The two segments are releasably sealable and are arranged to prevent communication between the food product and the nutraceutical while providing a shelf-stable environment for the storage of the contents. In the preferred embodiment, the two segments are peelable away from each other.

The first segment has an inner layer of polyethylene connected to an outer layer of polyester. Optionally, these layers may be separated by an oxygen-barrier coating such as evoh. The second segment also has an inner layer of polyethylene which is connected to an outer layer of nylon. These layers may also be separated by an oxygen-barrier coating such as evoh.

The present invention is also embodied in a nutritional combination of substances comprising a food product, a nutraceutical, and a package. The package has a first segment and a second segment that are releasably secured to house the food product and the nutraceutical within the package. The package is configured to provide a stable, contaminate-free environment for the food product and the nutraceutical.

In an alternative embodiment, the invention is embodied in a package for a food product and at least one nutraceutical. The package has a tray with a first receptacle in the tray to house the food product, and at least one additional receptacle to house one or more nutriceuticals. The package further has a first segment, and second segment, that are configured to secure the tray housing the food product and the nutraceutical between them.

Other features and advantages of the present invention should become more apparent from the following description of the preferred embodiments, taken in conjunction with the accompanying drawings, which illustrate, by way of example, the principles of the invention.

### BRIEF DESCRIPTION OF THE DRAWINGS

FIG. 1 is a perspective view of the combination food and nutraceutical product configured according to the present invention;

FIG. 2 is an enlarged side cross-sectional view of the combination food and nutraceutical product with the nutraceutical in shadow, taken along lines 2-2 in FIG. 1 illustrating the nutraceutical in ghost lines;

FIG. 3 is a perspective view of the food and nutraceutical product of FIG. 1 as partially opened by the consumer at its flap;

FIG. 4 is a perspective view of an alternative combination food and nutraceuticals product configured according to the present invention;

FIG. 5 is a perspective view of a tray used in connection with an alternative embodiment for a combination food and nutriceuticals product; and

FIG. 6 is a perspective view of the tray of FIG. 5 with a food product and nutriceuticals, in a wrapper.

### DETAILED DESCRIPTION OF THE PREFERRED EMBODIMENTS

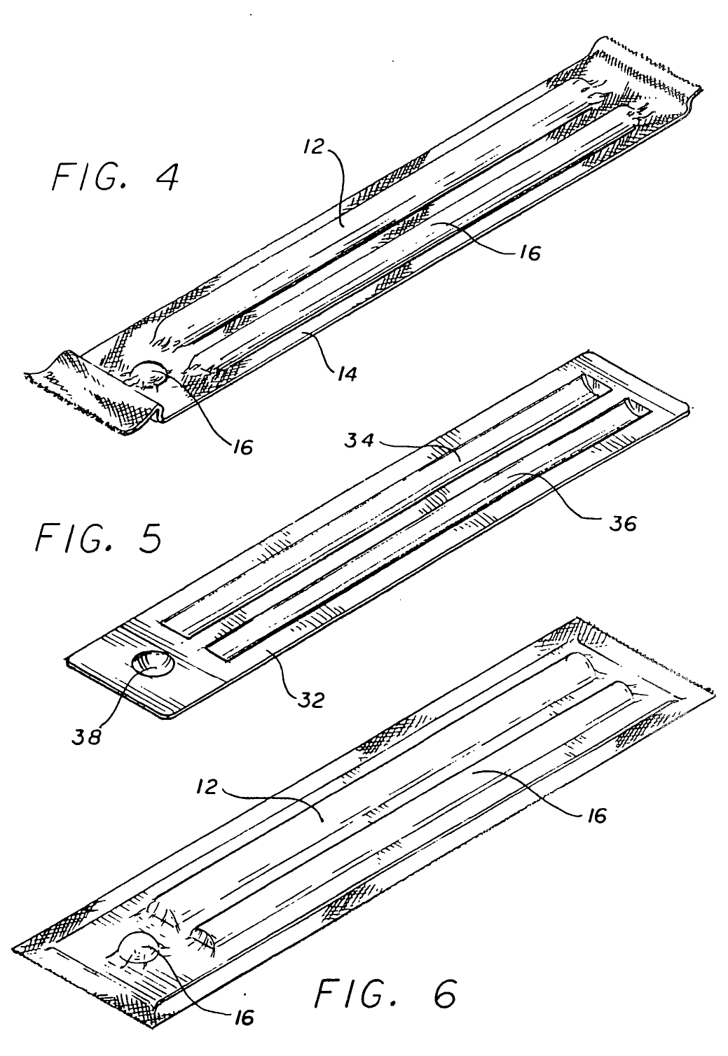

With reference now to FIGS. 1-3, there is shown a combination food and nutraceutical product 10 which includes a food item 12 and a nutraceutical 16 that are snugly contained within a package or wrapper 14. Preferably, the food item is, in part, a fruit substance that is sufficient in quantity to constitute a nutritious and/or immunity boosting snack for the consumer, though one of ordinary skill in the art will recognize that a wide variety of edible materials whether natural or synthetic may be used in connection with the invention. For example, see Ehrman, pending Application Ser. No. 09/308,316, herein fully incorporated by reference. The nutraceutical is preferably a pill, though it is known that nutraceuticals may take other forms such as liquids, powders, or a solid (in the case of a functional food or a medical food). If a non-pill nutraceutical is utilized by the invention, then an additional package for the nutraceutical to be contained within the wrapper may be employed such as a plastic or wax container which is tearable to access a liquid held inside. Alternatively, it will be appreciated that a plurality of nutraceuticals of varying shapes and sizes may be used in connection with the current invention as illustrated in FIG. 4.

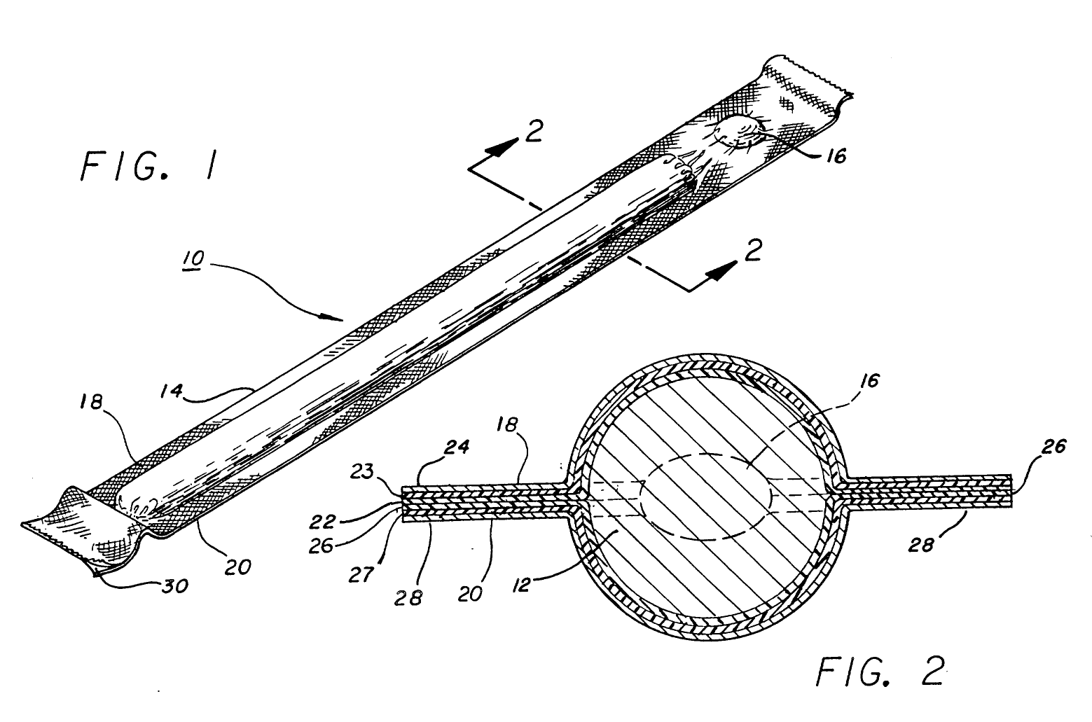

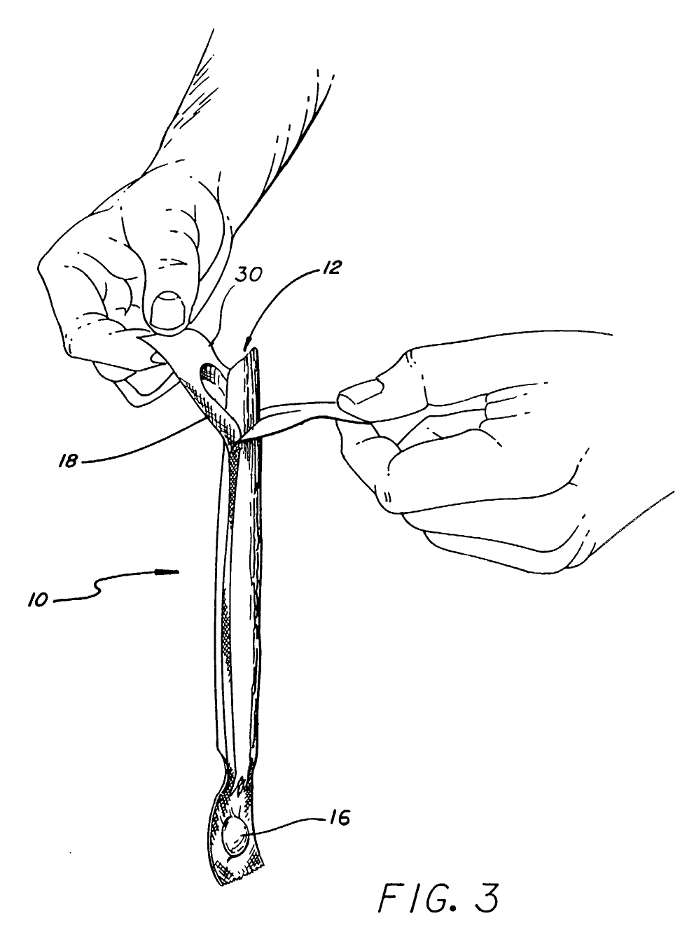

The wrapper 14 includes a first segment 18 and a second segment 20 that are together particularly adapted for containment of the food item 12 and the nutraceutical 16 and for relatively easy access to the food item and the nutraceutical. The wrapper 14 is also advantageously made of a suitable material which snugly contains the food item 12 and the nutraceutical 16 and facilitates prompt and easy removal of the food item and nutraceutical from the wrapper when consumption is desired. To this end, as shown in FIGS. 2-3, the two segments 18 and 20 are joined together around the food item 12 and nutraceutical 16 by utilizing conventional thermal pressurization and seal food packing equipment, such as thermal form and fill machines available from Multivac, Dixie Union, and Tiromat. Specifically, the first segment 18 includes an approximately 2.0 mils thick inner layer 22 of high-octene, linear low-density polyethelyene (“LLDPE”) that is laminated to an about 50 gauge polyester outer layer 24 made of polyester or a biaxially oriented polypropolene. Further, a first oxygen-barrier coating 23, such as that available under the trademark SARAN, is applied in liquid form, as is well understood by those skilled in the art, between the layers 22 and 24 during manufacture so as to render the segment 18 less permeable to protect the food from contaminants. The second segment 20 in turn includes a similar inner layer 26 of LLDPE and an about 5.0 mils thick outer layer 28 of a suitable thermally formable material, such as nylon or cast polypropolene. The use of such an outer layer 28 for segment 20 helps ensure that the wrapper will closely conform to the shape of the food item 12 and the nutraceutical 16. Correspondingly, the outer layer 24 provides for better adhesive and sealing characteristics for the wrapper 14. Similarly, a second oxygen-barrier coating 27, such as evoh, is applied in liquid form during manufacture such that it is sandwiched between the layers 26 and 28 to lessen permeability. In lieu of LLDPE, the inner layers 22 and 26 can be made of any other polyethelyne or an ionomer that has the requisite sealing characteristics.

As shown in FIG. 1 and FIG. 3, the two segments 18 and 20 are peelable and together create a seal that effectively extends around the food item 12 and the nutraceutical 16 (whether in the shape of a pill, or as a small container containing a liquid or powder or other food mass), while also defining an opening or flap 30 at the top end of the wrapper 14 above where the seal terminates. This facilitates peeling without prematurely exposing the food item. The combination food and nutraceutical product 10 is then opened by grasping the top portion of each segment at the flap and peeling each segment back relative to the other. It will be appreciated that a variety of other materials can be utilized to create a wrapper having suitable sealing and peelability characteristics. For example, a second opening or flap may be placed at the bottom end of the wrapper 14 to allow for the nutraceutical 16 to be individually removed from the wrapper. Or the nutraceutical 16 may be placed within the top portion of the wrapper 14 such that the nutraceutical is accessible prior to the food item 12 upon peeling back the flaps 30.

An alternative embodiment as shown in FIGS. 5-6, includes a generally rectangular tray 32 with a series of receptacles 34, 36, 38. These receptacles are preferably indentations into the tray particularly fitted for housing a certain food product or nutraceutical to be placed therein. As seen in FIG. 6, the food product 12 is placed within a first receptacle 34, a nutriceutical 16 such as honey contained in a tubular cylindrical tube is placed within a second receptacle 36 generally parallel to the placement of a food product, and an additional nutriceutical 16 such as a pill is placed in a third receptacle 38 at one end of the food product and other nutriceutical. The wrapper 14 for the alternative embodiment is applied around the tray in the same manner as described above so as to seal the tray and its contents. It will be appreciated by one of ordinary skill in the art that the tray is used to further the structural strength of the combination food and nutraceuticals product and can also be modified to house any variety of food products and nutraceuticals. Furthermore, the nutraceuticals placed within the tray may also be sealed within the tray receptacles prior to the introduction of the wrapper.

Although the invention has been described in detail with reference only to the presently preferred devices, those of ordinary skill in the art will appreciate that various modifications can be made without departing from the invention. For example, it should be appreciated that a plurality of nutraceuticals or food items may be secured by the packaging. It should also be appreciated that traditional medicinal substances such as cough syrup, antihistamines and other commonly used medicines may be used in connection with the current invention. Accordingly, the invention is defined only by the following claims.

What is claimed is:

1. A package for a food product and a nutraceutical, the package comprising:
a first segment;
a second segment; and
wherein said first segment and said second segment are configured to secure the food product and the nutraccutical between said first segment and said second segment.

2. The package of claim 1, wherein said first segment and said second segment are configured to prevent contamination between the food product and the nutraceutical.

3. The package of claim 1, wherein said first segment and said second segment are configured to releasably secure the food product and the nutraceutical.

4. The package of claim 3, wherein said first segment and said second segment form a peelable seal around the food product and the nutraceutical.

5. The package of claim 4, wherein said first segment has an inner layer of polyethylene laminated to an outer layer of polyester.

6. The package of claim 5 further comprising an oxygen-barrier coating between said inner layer and said outer layer.

7. The package of claim 6, wherein said oxygen-barrier coating is evoh.

8. The package of claim 3, wherein said second segment has an inner layer of polyethylene laminated to an outer layer of nylon.

9. The package of claim 8 further comprising an oxygen-barrier coating between said inner layer and said outer layer.

10. The package of claim 9, wherein said oxygen-barrier coating is evoh.

11. The package of claim 1, wherein the food product is made in part from fruit.

12. The package of claim 1, wherein the food product is made in part from synthetic food products.

13. The package of claim 1, wherein said nutraceutical includes a pill.

14. The package of claim 1, wherein said nutraceutical includes a food product.

15. The package of claim 1, wherein said nutraceutical includes a liquid contained within a container.

16. A wrapper for a food product and a nutraceutical, the wrapper comprising:
housing means for housing the food product and the nutraceutical such that contamination between the food product and the nutraceutical is prevented; and
sealing means for releasably securing the food product and the nutraceutical within said housing means.

17. A nutritional combination of substances comprising:
a food product;
a nutraceutical; and
a package comprising:
a first segment;
a second segment; and
wherein said first segment and said second segment are releasably secured to house said food product and said nutraceutical within said package such that contamination between said food product and said nutraceutical is prevented.

18. A package for a food product and at least one nutraceutical, the package comprising:
a tray;
a first receptacle in said tray configured to house the food product;
at least one additional receptacle in said tray configured to house the at least one nutriceutical;
a first segment;
a second segment; and
wherein said first segment and said second segment are configured to secure the tray housing the food product and the at least one nutraceutical between said first segment and said second segment.
